(19) United States
(12) Patent Application Publication
(10) Pub. No.: US 2006/0285322 A1
(43) Pub. Date: Dec. 21, 2006

(54) Diffuser panel, backlight unit, electro-optic device, electronic device, and method for manufacturing backlight unit

(75) Inventors: Hironori Hasei, Okaya (JP); Akira Inagaki, Suwa (JP); Mitsuru Kuribayashi, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/440,987

(22) Filed: May 25, 2006

(30) Foreign Application Priority Data
Jun. 15, 2005 (JP) 2005-174679

(51) Int. Cl. F21S 4/00

(52) U.S. Cl. 362/225; 362/23; 362/235

(57) ABSTRACT

A diffuser panel includes a diffuser panel section that irradiates a display unit with light emitted from a light source while diffusing the light, the diffuser panel section having a first surface that faces the display unit, wherein the first surface is coated with a first material having a lower thermal emissivity than that of a material of the diffuser panel section.

### BACKGROUND

1. Technical Field

The present invention relates to a diffuser panel, a backlight unit, an electro-optic device, an electronic device, and a method for manufacturing a backlight unit.

2. Related Art

In recent years, as liquid crystal display devices are becoming larger, there is a concern about, e.g., increase in the amount of heat generated from light sources, which may cause malfunction of display units as a result of increased temperature of the inside of the devices. For preventing an excessive increase in temperature of the display units, JP-A-2005-17414 discloses a liquid crystal display device in which a reflector plate and a cabinet are coated with a high thermal emissivity material with the intention to prevent increase in temperature by thus discharging generated heat to the outside. In addition, an optical sheet is coated with a low thermal emissivity material to prevent an excessive increase in temperature of a display unit.

JP-A-2005-17414 is an example of related art.

The liquid crystal display device as described in the example, however, has a problem in that a diffuser panel undergoes increase in temperature owing to the heat radiating from light sources, which causes the heat to radiate toward the display unit, resulting in decreased reliability of the display unit.

### SUMMARY

An advantage of the invention is to provide a diffuser panel, a backlight unit, an electro-optic device, an electronic device, and a method for manufacturing a backlight unit, which are capable of preventing an excessive increase in temperature of a display unit.

According to one aspect of the invention, a diffuser panel includes a diffuser panel section that irradiates a display unit with light emitted from a light source while diffusing the light. Further, the diffuser panel section has a first surface that faces the display unit. Still further, the first surface is coated with a first material having a lower thermal emissivity than that of a material of the diffuser panel section.

Thus, since the first surface, which is coated with a material having a low thermal emissivity, faces the display unit, the amount of heat radiating toward the display unit decreases. Therefore, a large increase in temperature of the display unit can be prevented.

It is preferable that in the diffuser panel, of a central portion and an edge portion of the first surface, at least the central portion be coated with the first material.

Thus, since at least the central portion of the first surface is coated with a material having a low thermal emissivity, a large increase in temperature of the display unit can be prevented.

It is preferable that in the diffuser panel, the edge portion be also coated with the first material, and that a coat of the central portion have a smaller thickness than a coat of the edge portion.

Thus, the first surface is coated with a material having a low thermal emissivity such that a coat of the central portion will have a smaller thickness than a coat of the edge portion. Therefore, even if the material has a relatively low transparency, a large reduction in the amount of transmitted light can be prevented as a result of the coat of the central portion being thinner.

It is preferable that in the diffuser panel, the diffuser panel section further have a second surface opposed to the first surface, and that the second surface be coated with a second material having a higher thermal emissivity than that of the material of the diffuser panel section.

Thus, since the second surface coated with a material having a high thermal emissivity is the surface opposite to the first surface that faces the display unit, heat is discharged by heat radiation in the direction of the surface opposite to the substrate surface that faces the display unit. This makes it possible to decrease the amount of heat radiating toward the display unit and prevent a large increase in temperature of the display unit.

It is preferable that in the diffuser panel, of a central portion and an edge portion of the second surface, at least the central portion of the second surface be coated with the second material.

Thus, since the central portion is coated with a material having a high thermal emissivity, heat is discharged by heat radiation in the direction of the surface opposite to the substrate surface that faces the display unit, a large increase in temperature of the display unit can be prevented. Further, also coating the edge portion with a material having a high thermal emissivity can further prevent the increase in temperature of the display unit.

It is preferable that in the diffuser panel, the edge portion of the second surface be also coated with the second material, and that a coat of the central portion of the second surface have a smaller thickness than a coat of the edge portion of the second surface.

Thus, the second surface is coated with a material having a high thermal emissivity such that a coat of the central portion will have a smaller thickness than a coat of the edge portion. Therefore, a large reduction in the amount of transmitted light can be prevented as a result of the coat of the central portion being thinner.

According to another aspect of the invention, a backlight unit includes: a light source section that faces a display unit and includes a light source and a reflector plate that reflects light emitted from the light source; and a diffuser panel that diffuses the light to be directed toward the display unit. Further, the diffuser panel is the diffuser panel as described above. Still further, the reflector plate is coated with a material having a higher thermal emissivity than that of a material of the reflector plate.

Thus, since the reflector plate is coated with a material having a high thermal emissivity, heat emitted from the light source is discharged by heat radiation in the direction opposite to the display unit relative to the light source. Therefore, a large increase in temperature of the display unit can be prevented.

According to yet another aspect of the invention, an electro-optic device that faces a display unit includes the backlight unit as describe above.

Thus, heat emitted from the light source is discharged in the direction opposite to the display unit relative to the light source. This makes it possible to reduce the increase in temperature of the display unit and thus to provide an electro-optic device with high reliability.

According to yet another aspect of the invention, an electronic device has attached thereto the electro-optic device as described above.

This makes it possible to prevent a large increase in temperature of the display unit and thus to provide an electronic device with high reliability.

Yet another aspect of the invention is a method for manufacturing a backlight unit having a light source section and a diffuser panel section, the light source section facing a display unit and including a light source and a reflector plate that reflects light emitted from the light source, the diffuser panel section diffusing the light to be directed toward the display unit. The method includes: a) discharging, upon a first surface of the diffuser panel section, which has a light-transmitting property, a first liquid material having a lower thermal emissivity than that of a material of the diffuser panel section to coat the first surface; b) discharging, upon a second surface of the diffuser panel section opposed to the first surface, a second liquid material having a higher thermal emissivity than that of the material of the diffuser panel section to coat the second surface; and c) assembling the diffuser panel section and the light source section disposed on the second surface side of the diffuser panel section such that the first surface will face the display unit.

Thus, a material having a lower thermal emissivity than that of a substrate material is discharged upon the first surface, whereas a material having a higher thermal emissivity than that of the substrate material is discharged upon the second surface, which is opposed to the first surface. In addition, the diffuser panel section and the light source section are assembled such that the first surface will face the display unit. As a result, a large amount of heat from a light source of an electro-optic device is discharged by heat radiation in the direction opposite to the display unit relative to the light source. Thus, a large increase in temperature of the display unit can be prevented.

It is preferable that in the method for manufacturing the backlight unit, the step a) include discharging a thick film and discharging a thin film. In this case, in the discharging of a thick film, the first liquid material is discharged upon an edge portion of the first surface to coat the edge portion, and in the discharging of a thin film, the first liquid material is discharged upon a central portion of the first surface to coat the central portion. In addition, coating of the edge and central portions is performed such that a coat of the central portion will have a smaller thickness than a coat of the edge portion.

Thus, a material having a low thermal emissivity is discharged upon the central portion of the first surface such that the resulting coat will have a smaller thickness than that of a coat of the edge portion. Therefore, a large reduction in the amount of transmitted light can be prevented as a result of the coat of the central portion being thinner.

It is preferable that in the method for manufacturing the backlight unit, the step b) include discharging a thick film and discharging a thin film. In this case, in the discharging of a thick film, the second liquid material is discharged upon an edge portion of the second surface to coat the edge portion, and in the discharging of a thin film, the second liquid material is discharged upon a central portion of the second surface to coat the central portion. In addition, coating of the edge and central portions is performed such that a coat of the central portion will have a smaller thickness than a coat of the edge portion.

Thus, a material having a high thermal emissivity is discharged upon the central portion of the second surface such that the resulting coat will have a smaller thickness than that of a coat of the edge portion. Therefore, a large reduction in the amount of transmitted light can be prevented as a result of the coat of the central portion being thinner.

According to yet another aspect of the invention, a backlight unit is manufactured using the method as described above.

Thus, it is possible to provide a backlight unit that is capable of reducing the amount of heat radiating toward a display unit and preventing a large increase in temperature of the display unit.

### BRIEF DESCRIPTION OF THE DRAWINGS

The invention will be described with reference to the accompanying drawings, wherein like numbers reference like elements.

FIGS. 1A and 1B are, respectively, a cross-sectional view and a plan view of a structure of a diffuser panel.

FIG. 2 is a cross-sectional view illustrating a backlight unit.

FIG. 3 is a cross-sectional view illustrating a liquid crystal display device as an electro-optic device.

FIG. 4 is a perspective view illustrating a television receiver as an electronic device.

FIGS. 5A to 5G illustrate steps in a method for manufacturing a backlight unit.

FIGS. 6A and 6B are, respectively, a perspective view, partly cut away, and a detailed cross-sectional view of a structure of a discharge head.

### DESCRIPTION OF EXEMPLARY EMBODIMENTS

Hereinafter, embodiments of the invention will be described with reference to the drawings.

Structure of Diffuser Panel

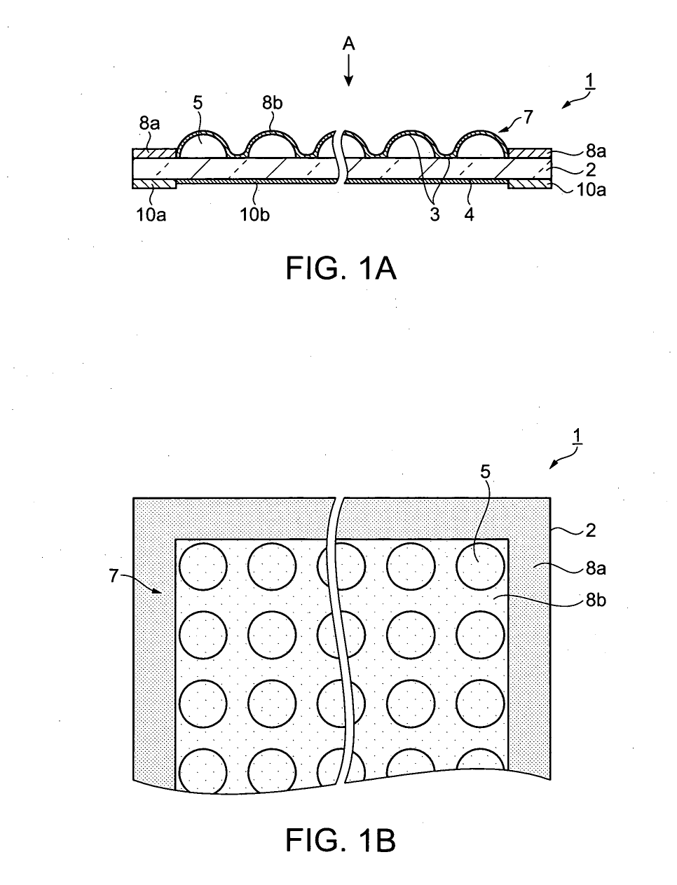

First, a structure of a diffuser panel will now be described. FIGS. 1A and 1B are schematic views of the structure of the diffuser panel. FIG. 1A and FIG. 1B are, respectively, a cross-sectional view and a plan view of the structure of the diffuser panel.

In FIG. 1A, the diffuser panel 1 includes a substrate 2 having a light-transmitting property, and a diffuser panel section 7 constructed of micro lenses 5 formed on the substrate 2. A first surface 3 of the diffuser panel section 7 has formed thereon low thermal emissivity films 8a and 8b, which have a low thermal emissivity. A second surface 4, which is opposed to the first surface 3, has formed thereon high thermal emissivity films 10a and 10b, which have a high thermal emissivity.

The substrate 2 is made of inorganic material such as glass. Other exemplary materials usable for the substrate 2 include transparent resin materials having light-transmitting properties, such as acrylic resin, quartz, polycarbonate, and polyester.

The first surface 3 of the diffuser panel section 7 has a central portion and an edge portion. The central portion corresponds at least to an effective area of a display region. The edge portion corresponds to an area other than the display region (see FIG. 1B). The central portion has the low thermal emissivity film 8b formed thereon. The edge portion has the low thermal emissivity film 8a formed thereon. The low thermal emissivity film 8b and the low thermal emissivity film 8a are formed such that the low thermal emissivity film 8b has a smaller thickness than the low thermal emissivity film 8a.

The low thermal emissivity films 8a and 8b are made of a material having a lower thermal emissivity than a material of the substrate 2. For example, a material having a thermal emissivity of about 0.1 or less, e.g., silver, aluminum, copper, gold, etc., is used for metal coating of the low thermal emissivity films 8a and 8b. In the case where resin is employed as the material of the substrate 2, indium tin oxide (ITO), indium zinc oxide (IZO), or the like may be employed as the material of the low thermal emissivity films 8a and 8b.

The second surface 4, which is opposed to the first surface 3 of the diffuser panel section 7, has a central portion and an edge portion. The central portion corresponds at least to the effective area of the display region. The edge portion corresponds to the area other than the display region. The central portion has the high thermal emissivity film 10b formed thereon. The edge portion has the high thermal emissivity film 10a formed thereon. The high thermal emissivity film 10b and the high thermal emissivity film 10a are formed such that the high thermal emissivity film 10b has a smaller thickness than the high thermal emissivity film 10a.

For coating of the high thermal emissivity films 10a and 10b, a material having a higher thermal emissivity than that of the material of the substrate 2 is employed. Examples of such materials include lacquer and enamel.

The micro lenses 5, which have a substantially hemispherical shape, are formed on the substrate 2 in substantially evenly-spaced arrangement.

For the micro lenses 5, ultraviolet curable acrylic resin or ultraviolet curable epoxy resin may be employed. As an exemplary precursor, a polyimide precursor may be cited.

The ultraviolet curable resin contains a photopolymerization initiator and at least one of a prepolymer, an oligomer, and a monomer.

In the case of the ultraviolet curable acrylic resin, exemplary prepolymers or oligomers that can be used include: acrylates such as epoxy acrylate, urethane acrylate, polyester acrylate, polyether acrylate, and spiroacetal acrylate; and methacrylates such as epoxy methacrylate, urethane methacrylate, polyester methacrylate, and polyether methacrylate.

Exemplary monomers include: monofunctional monomers such as 2-ethylhexyl acrylate, 2-ethylhexyl methacrylate, 2-hydroxyethyl acrylate, 2-hydroxyethyl methacrylate, n-vinyl-2-pyrrolidone, Carbitol acrylate, tetrahydrofurfuryl acrylate, isobornyl acrylate, dicyclopentenyl acrylate, and 1,3-butanediol acrylate; bifunctional monomers such as 1,6-hexanediol diacrylate, 1,6-hexanediol methacrylate, neopentyl glycol acrylate, polyethylene glycol diacrylate, and pentaerythritol diacrylate; and multifunctional monomers such as trimethylolpropane triacrylate, trimethylolpropane trimethacrylate, pentaerythritol triacrylate, and dipentaerythritol hexacrylate.

Exemplary photopolymerization initiators include: acetophenone such as 2,2-dimethoxy-2-phenyl acetophenone; butyl phenone such as α-hydroxy isobutyl phenone and p-isopropyl-α-hydroxy isobutyl phenone; halogenated acetophenone such as p-tert-butyl dichloro acetophenone and α,α-dichlor-4-phenoxy acetophenone; benzophenone such as benzophenone, and n,n-tetraethyl-4,4-diamino benzophenone; benzyl such as benzyl, and benzyldimethyl ketal; benzoin such as benzoin and benzoinalkylether; oxime such as 1-phenyl-1,2-propanedione-2-(o-ethoxycarbonyl) oxime; xanthone such as 2-methylthio xanthone, and 2-chlorothio xanthone; benzoin ether such as benzoin ether and isobutyl benzoin ether; and radical forming compounds such as Michler's ketone. A resin obtained by curing the ultraviolet curable acrylic resin has an advantage of high transparency.

Exemplary polyimide precursors include polyamic acid, and polyamic acid long-chain alkyl ester. A polyimide resin obtained by subjecting the polyimide precursor to thermosetting has a transmittance of 80% or higher in the visible light range, and a high refractive index, i.e., that of 1.7 to 1.9. Thus, excellent lens effect is achieved.

As a result of the above-described structure, in which the first surface 3 of the diffuser panel 1 has formed thereon the low thermal emissivity films 8a and 8b having a low thermal emissivity, heat becomes less inclined to radiate toward the display unit side of the first surface 3. Also, because the second surface 4 of the diffuser panel 1 has formed thereon the high thermal emissivity films 10a and 10b having a high thermal emissivity, the amount of heat radiating toward the opposite side of the first surface 3 increases in percentage.

Structure of Backlight Unit

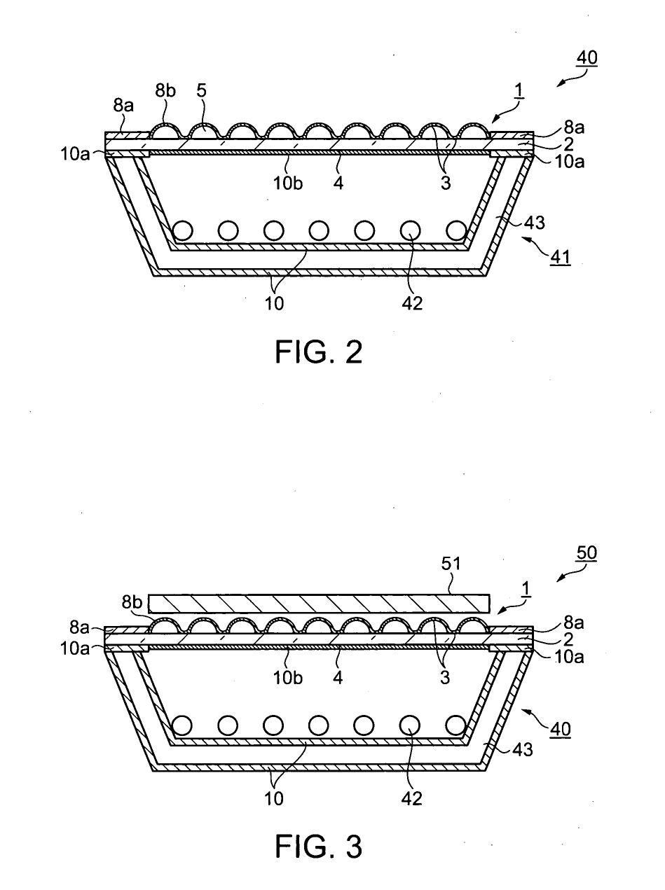

Next, a structure of a backlight unit will now be described. FIG. 2 is a schematic cross-sectional view of a backlight unit of a type to be disposed directly behind a display unit.

In FIG. 2, a backlight unit 40 is constructed of the diffuser panel 1 and a light source section 41.

The light source section 41 includes light sources 42 and a reflector plate 43. The light sources 42 are disposed directly below the second surface 4 of the diffuser panel 1 such that the light sources 42 are arranged substantially in parallel with the diffuser panel 1 and evenly spaced from each other. The reflector plate 43 is arranged at the back and sides of the light sources 42. The light sources 42 are lighting devices. Examples of the light sources 42 include cold cathode fluorescent tubes. The reflector plate 43 is formed of an iron plate, an aluminum plate, or the like.

On front and back surfaces of the reflector plate 43 is formed a high thermal emissivity film 10, which has a higher thermal emissivity than a material of the reflector plate 43. Exemplary materials usable for the high thermal emissivity film 10 include lacquer and enamel.

As a result of the above-described structure, in which the front and back surfaces of the reflector plate 43 have formed thereon the high thermal emissivity film 10 having a high thermal emissivity, the amount of heat radiating from the light sources 42 in a direction opposite to that of the diffuser panel 1 increases in percentage, while heat becomes less inclined to radiate in the direction of the diffuser panel 1.

Structure of Electro-Optic Device

Next, a structure of an electro-optic device will now be described. FIG. 3 is a schematic cross-sectional view of a liquid crystal display device as an electro-optic device.

In FIG. 3, a liquid crystal display device 50 is constructed of the backlight unit 40 and a liquid crystal display unit 51, which functions as a display unit to make a display, responsive to light emitted from the backlight unit 40. The liquid crystal display unit 51 is arranged so as to be substantially in parallel with the diffuser panel 1.

As a result of the above-described structure, in which the first surface 3 of the diffuser panel 1 has formed thereon the low thermal emissivity films 8a and 8b having a low thermal emissivity, heat becomes less inclined to radiate toward the liquid crystal display unit 51, which is disposed above the first surface 3. Also, because the front and back surfaces of the reflector plate 43 have formed thereon the high thermal emissivity film 10 having a high thermal emissivity, the amount of heat radiating in a direction opposite to that of the liquid crystal display unit 51 increases in percentage, while heat becomes less inclined to radiate in the direction of the liquid crystal display unit 51.

Structure of Electronic Device

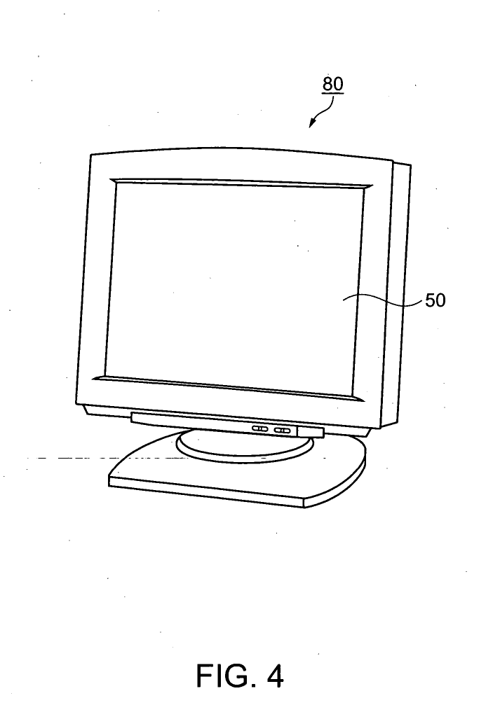

Next, a structure of an electronic device according to one embodiment of the invention will now be described. FIG. 4 is a schematic perspective view of a television receiver as an electronic device. In FIG. 4, the liquid crystal display device 50 as an electro-optic device is attached to a display section of a television receiver 80. On the back of the television receiver 80 are formed a plurality of heat vents (not shown) for discharging some of the heat radiating from the light sources 42 to the outside.

As a result of the above-described structure, in which the first surface 3 of the diffuser panel 1 has formed thereon the low thermal emissivity films 8a and 8b having a low thermal emissivity, heat becomes less inclined to radiate toward the liquid crystal display unit 51, which is disposed above the first surface 3. Also, because the front and back surfaces of the reflector plate 43 have formed thereon the high thermal emissivity film 10 having a high thermal emissivity, the amount of heat radiating in a direction opposite to that of the liquid crystal display unit 51 increases in percentage. In addition, the heat is discharged to the outside through the heat vents formed on the back of the television receiver 80. Thus, an excessive increase in temperature of the television receiver 80 as a whole can be prevented.

Method for Manufacturing Diffuser Panel

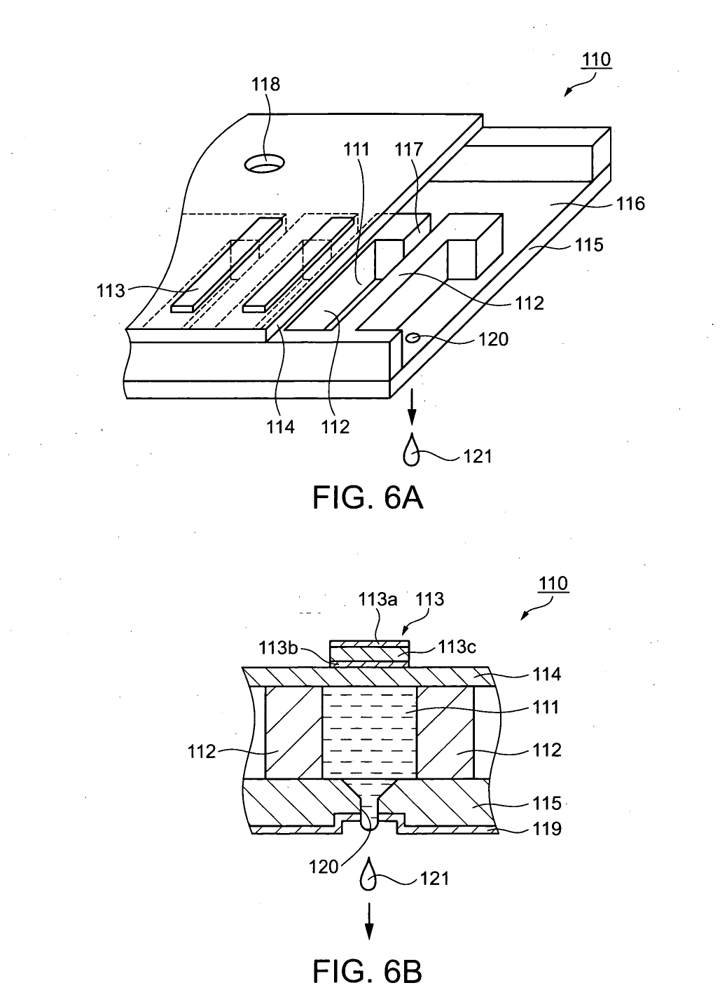

Next, a method for manufacturing a backlight unit according to one embodiment of the invention will now be described. First, a discharge head used in this manufacturing method will now be described. FIGS. 6A and 6B are respectively a perspective view, partly cut away, and a detailed cross-sectional view illustrating the structure of the discharge head.

In FIG. 6A, a discharge head 110 includes a vibrating plate 114 and a nozzle plate 115. Between the vibrating plate 114 and the nozzle plate 115 is provided a liquid reservoir 116, which is always filled with a functional fluid supplied through a hole 118. Also, between the vibrating plate 114 and the nozzle plate 115 are positioned a plurality of banks 112. The vibrating plate 114, the nozzle plate 115, and a pair of banks 112 define a cavity 111 by surrounding it. A nozzle 120 is provided for each cavity 111. Accordingly, the number of cavities 111 is equal to that of nozzles 120. The liquid reservoir 116 supplies the functional fluid to the cavity 111 through a supply opening 117 positioned between the pair of banks 112.

As shown in FIG. 6B, a vibrator 113 is attached to the vibrating plate 114 so as to correspond to each cavity 111. The vibrator 113 includes a piezoelectric element 113c and a pair of electrodes 113a and 113b that sandwitch the piezoelectric element 113c. Applying a drive voltage to the pair of electrodes 113a and 113b causes the functional fluid to be discharged through the corresponding nozzle 120 in the form of droplets 121. A functional fluid repellent layer 119, which is, for example, a Ni-tetrafluoroethylene eutectoid plated layer, is provided at the peripheral region of the nozzle 120 in order, for example, to prevent the flying droplets 121 from deviating and the nozzle 120 from clogging. Note that, instead of the vibrator 113, an electrothermal conversion element may be employed to discharge the functional fluid. In this case, discharging of a material fluid can be achieved by using thermal expansion of the material fluid caused by the electrothermal conversion element.

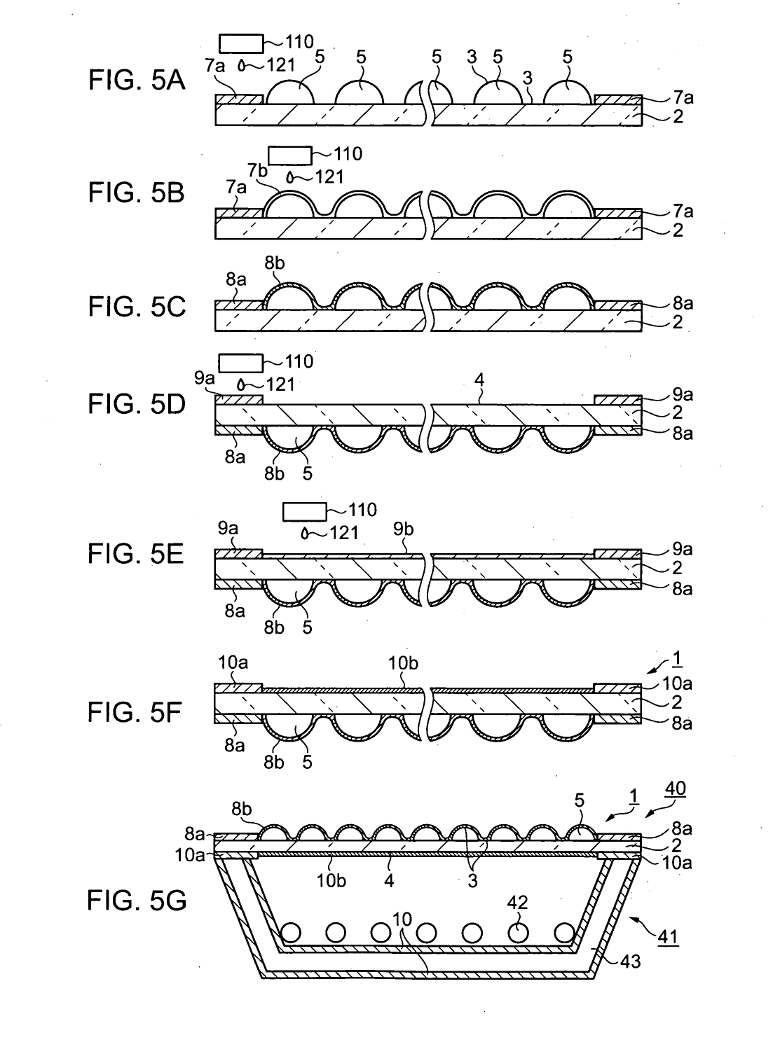

Next, the method for manufacturing the backlight unit will now be described. FIGS. 5A to 5G illustrate steps in the method for manufacturing the backlight unit.

FIG. 5A illustrates a thick film discharge step in a first discharge step. In this step, the discharge head 110 is caused to discharge, in the form of droplets 121, a liquid material 7a containing a material having a low thermal emissivity upon the edge portion of the first surface 3 of the substrate 2, which has the micro lenses 5 formed thereon, whereby the liquid material 7a is adhered onto the first surface 3.

FIG. 5B illustrates a thin film discharge step in the first discharge step. In this step, the discharge head 110 is caused to discharge a liquid material 7b having a low thermal emissivity upon the entire central portion of the first surface 3 of the substrate 2, whereby the liquid material 7b is adhered onto the substrate 2. In this step, discharging is controlled such that the liquid material 7b adhered onto the substrate 2 will have a smaller thickness than that of the liquid material 7a having a low thermal emissivity which has been adhered onto the substrate 2 in the thick film discharge step illustrated by FIG. 5A.

FIG. 5C illustrates a first film forming step. In this step, the materials 7a and 7b having a low thermal emissivity are hardened to form solid films, i.e., the low thermal emissivity films 8a and 8b having a low thermal emissivity.

FIG. 5D illustrates a thick film discharge step in a second discharge step. In this step, the discharge head 110 is caused to discharge, in the form of droplets 121, a liquid material 9a containing a material having a high thermal emissivity upon the edge portion of the second surface 4 of the substrate 2, whereby the liquid material 9a is adhered onto the second surface 4.

FIG. 5E illustrates a thin film discharge step in the second discharge step. In this step, the discharge head 110 is caused to discharge a liquid material 9b having a high thermal emissivity upon the entire central portion of the second surface 4 of the substrate 2, whereby the liquid material 9b is adhered onto the second surface 4. In this step, discharging is controlled such that the liquid material 9b adhered onto the substrate 2 will have a smaller thickness than that of the liquid material 9a having a high thermal emissivity which has been adhered onto the substrate 2 in the thick film discharge step illustrated by FIG. 5D.

FIG. 5F illustrates a second film forming step. In this step, the liquid materials 9a and 9b having a high thermal emissivity are hardened to form solid films, i.e., the high thermal emissivity films 10a and 10b having a high thermal emissivity.

FIG. 5G illustrates an assembling step. In this step, the diffuser panel 1 manufactured by the above steps and the light source section 41 are assembled. In this assembling, the reflector plate 43 is joined, at the edge portion, to the second surface 4 of the diffuser panel 1 so that the light source section 41 is disposed on the second surface 4 side.

Therefore, the above embodiments produce the following effects.

First, on the first surface 3 are formed the low thermal emissivity films 8a and 8b having a low thermal emissivity, whereas on the second surface 4 are formed the high thermal emissivity films 10a and 10b having a high thermal emissivity. Therefore, heat becomes less inclined to radiate toward the liquid crystal display unit 51 side of the first surface 3, and thus, it is made possible to prevent an excessive increase in temperature of the liquid crystal display unit 51.

Further, the low thermal emissivity film 8b is formed on the central portion of the first surface 3 so as to have a small thickness. This makes it possible to prevent a large reduction in the amount of light transmitted to the liquid crystal display unit 51.

Still further, the low thermal emissivity film 8a is formed on the edge portion of the first surface 3. Therefore, heat radiation through the edge portion can be controlled.

Still further, in the backlight unit 40, the high thermal emissivity film 10 having a high thermal emissivity is formed on the front and back surfaces of the reflector plate 43 of the light source section 41. This helps heat to radiate in a direction opposite to that of the diffuser panel 1, making it possible to prevent an excessive increase in temperature of the diffuser panel 1.

Still further, in the liquid crystal display device 50, the low thermal emissivity films 8a and 8b having a low thermal emissivity are formed on the first surface 3 of the diffuser panel 1, whereas the high thermal emissivity films 10, 10a, and 10b having a high thermal emissivity are formed on the second surface 4 and the reflector plate 43. This helps heat radiating from the light sources 42 to be discharged in a direction opposite to that of the liquid crystal display unit 51. Thus, an excessive increase in temperature of the liquid crystal display unit 51 can be prevented, resulting in an improved reliability of the liquid crystal display device 50.

Still further, the low thermal emissivity films 8a and 8b and the high thermal emissivity films 10a and 10b are formed by using an inkjet process. Therefore, process design can be performed easily for the liquid crystal display unit 51 of any size.

The invention is not limited to the above-described embodiments. Exemplary variants will now be described below.

First, in the above-described embodiments, it is so arranged that the thickness of the low thermal emissivity film 8a is greater than that of the low thermal emissivity film 8b. However, the invention is not limited to this. The low thermal emissivity film 8a may be formed so as to have substantially the same thickness as that of the low thermal emissivity film 8b. This makes it possible to perform the discharging of the liquid materials in the first discharge step illustrated by FIGS. 5A and 5B under the identical condition, resulting in easier process control.

Second, in the above-described embodiments, it is so arranged that the thickness of the high thermal emissivity film 10a is greater than that of the high thermal emissivity film 10b. However, the invention is not limited to this. The high thermal emissivity film 10a may be formed so as to have substantially the same thickness as that of the high thermal emissivity film 10b. This makes it possible to perform the discharging of the liquid materials in the second discharge step illustrated by the FIGS. 5D and 5E under the identical condition, resulting in easier process control.

Third, in the above-described embodiments, the low thermal emissivity film 8b is formed so as to cover the micro lenses 5 formed on the first surface 3. However, the invention is not limited to this. The low thermal emissivity film 8b may be formed at positions specific thereto on the first surface 3. For example, the low thermal emissivity film 8b may be formed only at positions other than the top portions of the micro lenses 5. This makes it possible to increase the amount of transmitted light while reducing the amount of radiated heat.

Fourth, in the above-described embodiments, the high thermal emissivity films 10a and 10b are formed on the second surface 4 such that the films are thinner on the central portion than on the edge portion. However, the invention is not limited to this. For example, a high thermal emissivity film may be formed on the second surface 4 such that the film is thicker at positions coinciding with the perpendicular direction from the light sources 42 than at the other positions. This makes it possible to efficiently discharge heat generated from the light sources 42 to the outside.

Fifth, in the above-described embodiments, the low thermal emissivity films 8a and 8b are formed by using an inkjet process. However, the invention is not limited to this. For example, a sputter deposition process or the like may be used instead. Also, the sputter deposition process may be used only for the low thermal emissivity film 8b on the central portion of the first surface 3. Thus, the low thermal emissivity film 8b is formed on the central portion of the first surface 3 so as to have an exceedingly small thickness. As a result, a large reduction in the amount of transmitted light can be prevented.

Sixth, in the above-described embodiments, glass is exemplarily employed as the material of the substrate 2, and the coating of the high thermal emissivity films 10a and 10b is performed on the second surface 4. However, the invention is not limited to this. For example, transparent resin materials having light-transmitting properties, such as acrylic resin and polyester, may be used as the material of the substrate 2 while omitting the coating of the high thermal emissivity films 10a and 10b for the second surface 4. According to this modification also, since the acrylic resin or the like has a high thermal emissivity, heat is discharged by heat radiation in the direction of the surface opposite to the first surface 3 of the substrate 2, which faces the liquid crystal display unit 51. This makes it possible to reduce the amount of heat radiating toward the liquid crystal display unit 51, preventing an excessive increase in temperature of the liquid crystal display unit 51.

What is claim is:

1. A diffuser panel comprising a diffuser panel section that irradiates a display unit with light emitted from a light source while diffusing the light, the diffuser panel section having a first surface that faces the display unit, wherein
the first surface is coated with a first material having a lower thermal emissivity than that of a material of the diffuser panel section.

2. The diffuser panel according to claim 1, wherein
of a central portion and an edge portion of the first surface, at least the central portion is coated with the first material.

3. The diffuser panel according to claim 1, wherein,
the edge portion is also coated with the first material, and
a coat of the central portion has a smaller thickness than a coat of the edge portion.

4. The diffuser panel according to claim 1, wherein,
the diffuser panel section further has a second surface opposed to the first surface, and
the second surface is coated with a second material having a higher thermal emissivity than that of the material of the diffuser panel section.

5. The diffuser panel according to claim 4, wherein
of a central portion and an edge portion of the second surface, at least the central portion of the second surface is coated with the second material.

6. The diffuser panel according to claim 4, wherein,
the edge portion of the second surface is also coated with the second material, and
a coat of the central portion of the second surface has a smaller thickness than a coat of the edge portion of the second surface.

7. A backlight unit comprising:
a light source section that faces a display unit and includes a light source and a reflector plate that reflects light emitted from the light source; and
a diffuser panel that diffuses the light to be directed toward the display unit, wherein,
the diffuser panel is the diffuser panel of one of claims 1 to 6, and
the reflector plate is coated with a material having a higher thermal emissivity than that of a material of the reflector plate.

8. An electro-optic device that faces a display unit, the device comprising the backlight unit of claim 7.

9. An electronic device that has attached thereto the electro-optic device of claim 8.

10. A method for manufacturing a backlight unit having a light source section and a diffuser panel section, the light source section facing a display unit and including a light source and a reflector plate that reflects light emitted from the light source, the diffuser panel section diffusing the light to be directed toward the display unit, the method comprising:
a) discharging, upon a first surface of the diffuser panel section, which has a light-transmitting property, a first liquid material having a lower thermal emissivity than that of a material of the diffuser panel section to coat the first surface;
b) discharging, upon a second surface of the diffuser panel section opposed to the first surface, a second liquid material having a higher thermal emissivity than that of the material of the diffuser panel section to coat the second surface; and
c) assembling the diffuser panel section and the light source section disposed on the second surface side of the diffuser panel section such that the first surface will face the display unit.

11. The method according to claim 10, wherein,
the step a) includes discharging a thick film and discharging a thin film,
in the discharging of a thick film, the first liquid material is discharged upon an edge portion of the first surface to coat the edge portion,
in the discharging of a thin film, the first liquid material is discharged upon a central portion of the first surface to coat the central portion, and
coating of the edge and central portions is performed such that a coat of the central portion will have a smaller thickness than a coat of the edge portion.

12. The method according to claim 10, wherein,
the step b) includes discharging a thick film and discharging a thin film,
in the discharging of a thick film, the second liquid material is discharged upon an edge portion of the second surface to coat the edge portion,
in the discharging of a thin film, the second liquid material is discharged upon a central portion of the second surface to coat the central portion, and
coating of the edge and central portions is performed such that a coat of the central portion will have a smaller thickness than a coat of the edge portion.

13. A backlight unit manufactured using the method of claim 10.
